(19) United States
(12) Patent Application Publication
(10) Pub. No.: US 2018/0214948 A1
(43) Pub. Date: Aug. 2, 2018

(54) METHOD FOR MANUFACTURING THREE-DIMENSIONAL SHAPED OBJECT AND THREE-DIMENSIONAL SHAPED OBJECT

(71) Applicant: PANASONIC INTELLECTUAL PROPERTY MANAGEMENT CO., LTD., Osaka (JP)

(72) Inventors: Masanori MORIMOTO, Osaka (JP); Satoshi ABE, Osaka (JP); Isao FUWA, Osaka (JP); Akifumi NAKAMURA, Osaka (JP)

(73) Assignee: PANASONIC INTELLECTUAL PROPERTY MANAGEMENT CO., LTD., Osaka (JP)

(21) Appl. No.: 15/748,447

(22) PCT Filed: Feb. 8, 2016
(86) PCT No.: PCT/JP2016/000644

§ 371 Date: Jan. 29, 2018

(30) Foreign Application Priority Data
Jul. 31, 2015 (JP) 2015-152056

(51) Int. Cl. B22F 3/105; B22F 3/16; B29C 64/153; B22F 5/00

(52) U.S. Cl. CPC B22F 3/1055; B22F 3/16; B33Y 10/00; B22F 5/00; B29C 64/153

(57) ABSTRACT

In order to provide a manufacturing method of the three-dimensional shaped object having a more proper heat property to be used as a metal mold, there is provided a method for manufacturing a three-dimensional shaped object by alternate repetition of a powder-layer forming and a solidified-layer forming, the repetition comprising: (i) forming a solidified layer by irradiating a predetermined portion of a powder layer with a light beam, thereby allowing a sintering of the powder in the predetermined portion or a melting and subsequent solidification of the powder; and (ii) forming another solidified layer by forming a new powder layer on the formed solidified layer, followed by irradiation of a predetermined portion of the newly formed powder layer with the light beam, wherein the three-dimensional shaped object is manufactured such that it has a heat source element in the three-dimensional shaped object, and also has a surface in a form of a concavity-convexity, and wherein a main surface of the heat source element and the surface of the concavity-convexity have the same shape as each other.

### TECHNICAL FIELD

The disclosure relates to a method for manufacturing a three-dimensional shaped object and a three-dimensional shaped object. More particularly, the disclosure relates to a method for manufacturing a three-dimensional shaped object, in which a formation of a solidified layer is performed by an irradiation of a powder layer with a light beam, and a three-dimensional shaped object to be obtained by the method.

### BACKGROUND OF THE INVENTION

Heretofore, a method for manufacturing a three-dimensional shaped object by irradiating a powder material with a light beam has been known (such method can be generally referred to as “selective laser sintering method”). The method can produce the three-dimensional shaped object by an alternate repetition of a powder-layer forming and a solidified-layer forming on the basis of the following (i) and (ii):

(i) forming a solidified layer by irradiating a predetermined portion of a powder layer with a light beam, thereby allowing a sintering of the predetermined portion of the powder or a melting and subsequent solidification of the predetermined portion; and

(ii) forming another solidified layer by forming a new powder layer on the formed solidified layer, followed by similarly irradiating the powder layer with the light beam.

This kind of the manufacturing technology makes it possible to produce the three-dimensional shaped object with its complicated contour shape in a short period of time. The three-dimensional shaped object can be used as a metal mold in a case where inorganic powder material (e.g., metal powder material) is used as the powder material. While on the other hand, the three-dimensional shaped object can also be used as various kinds of models or replicas in a case where organic powder material (e.g., resin powder material) is used as the powder material.

Taking a case as an example wherein the metal powder is used as the powder material, and the three-dimensional shaped object produced therefrom is used as the metal mold, the selective laser sintering method will now be briefly described. A powder is firstly transferred onto abase plate 21 by a movement of a squeegee blade 23, and thereby a powder layer 22 with its predetermined thickness is formed on the base plate 21 (see FIG. 11A). Then, a predetermined portion of the powder layer is irradiated with a light beam “L” to form a solidified layer 24 (see FIG. 11B). Another powder layer is newly provided on the solidified layer thus formed, and is irradiated again with the light beam to form another solidified layer. In this way, the powder-layer forming and the solidified-layer forming are alternately repeated, and thereby allowing the solidified layers 24 to be stacked with each other (see FIG. 11C). The alternate repetition of the powder-layer forming and the solidified-layer forming leads to a production of a three-dimensional shaped object with a plurality of the solidified layers integrally stacked therein. The lowermost solidified layer 24 can be provided in a state of adhering to the surface of the base plate 21. Therefore, there can be obtained an integration of the three-dimensional shaped object and the base plate. The integrated “three-dimensional shaped object” and “base plate” can be used as the metal mold as they are.

### PATENT DOCUMENTS (RELATED ART PATENT DOCUMENTS)

PATENT DOCUMENT 1: Japanese Unexamined Patent Application Publication No. H01-502890
PATENT DOCUMENT 2: Japanese Unexamined Patent Application Publication No. 2000-73108

### DISCLOSURE OF THE INVENTION

### Problems to be Solved by the Invention

When the three-dimensional shaped object is used as the metal mold, a mold cavity is filled with a raw material for a molding in a melt state to finally obtain a molded article, the mold cavity being formed by a combination of so called “core side” and “cavity side”. Specifically, when the mold cavity is filled with the raw material for the molding in the melt state, pressurization step and cooling step for the raw material for the molding are performed for a solidification of thereof, the pressurization step being a step for pressurizing the raw material for the molding such that it spreads into a whole mold cavity, the cooling step being a step for cooling the raw material for the molding in the mold.

The cooling of the raw material for the molding may result from a transfer of a heat arising from the raw material for the molding filled in the mold cavity to the metal mold. However, when a needless earlier cooling of the raw material for the molding is performed, it is not possible to sufficiently pressurize the raw material for the molding in the mold cavity, which may lead to an occurrence of a molding defect. In this regard, JP PATENTs Nos. 3557926 and 5584019 have disclosed that the a use of the three-dimensional shaped object having a heater therein to be used as the metal mold results in a heating of the raw material for the molding in the mold cavity.

Inventors of the present application have found that a heat source element having a predetermined configuration in the three-dimensional shaped object may make an effective heating of the raw material for the molding difficult, the heat source element including a heater and a flow path for heating media. The difficulty of the effective heating may result from the following matters. Specifically, the heat source element to be generally used has a relatively simple shape of a cross sectional contour. For example, the simple shape includes a rectangular shape and a circular shape. In this case, it is supposed that the simple shape of the heat source element results in a difficulty of an uniform transfer of the heat arising therefrom to the mold cavity. Non-uniformnness of the heat transfer arising from the heat source element may cause a local portion where the needless earlier cooling of the raw material for the molding filled in the mold cavity is performed. Thus, a sufficient pressurization of the whole the raw material for the molding the mold cavity may be difficult, which may lead to the occurrence of the molding defect. For example, a molded article to be finally obtained may have a weld line, which may lead to technical problems such as a reduction of a shape accuracy of the molded article.

Under these circumstances, the present invention has been created. That is, an object of the present invention is to provide a manufacturing method of the three-dimensional shaped object having a more proper heat property to be used as a metal mold and the three-dimensional shaped object itself having a more proper heat property.

### Means for Solving the Problems

In order to achieve the above object, an embodiment of the present invention provides a method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by forming a new powder layer on the formed solidified layer, followed by irradiation of a predetermined portion of the newly formed powder layer with the light beam,

wherein the three-dimensional shaped object is manufactured such that it has a heat source element in the three-dimensional shaped object, and also has a surface in a form of a concavity-convexity, and

wherein a main surface of the heat source element and the surface of the concavity-convexity have the same shape as each other.

n order to achieve the above object, an embodiment of the present invention provides a three-dimensional shaped object comprising a heat source element therein,

wherein the three-dimensional shaped object has a surface in a form of a concavity-convexity, and

wherein a main surface of the heat source element and the surface of the concavity-convexity have the same shape as each other.

### Effect of the Invention

According to the present invention (i.e., the method for manufacturing the three-dimensional shaped object and the three-dimensional shaped object), it is possible to obtain the three-dimensional shaped object having the more proper heat property as the metal mold. Thus, when the three-dimensional shaped object is used as the metal mold, it is possible to more uniformly transfer a heat arising from the heat source element to the mold cacity.

### BRIEF DESCRIPTION OF THE DRAWINGS

FIG. 1 is a cross-sectional view schematically showing a three-dimensional shaped object to be obtained by a manufacturing method according to an embodiment of the present invention.

FIG. 2 is a cross-sectional view schematically showing a three-dimensional shaped object to be used as a metal mold.

FIGS. 3A-3D are cross-sectional views schematically showing steps over time in a manufacturing method according to an embodiment of the present invention.

FIG. 4 is a perspective view schematically showing a preferable configuration of a squeegee blade.

FIG. 5 is a cross-sectional view schematically showing a formation embodiment of a heat-insulating porous region.

FIG. 6 is a cross-sectional view schematically showing a provision embodiment of a protection part for a heat source element.

FIG. 7 is a cross-sectional view schematically showing a provision embodiment of a heat transfer part.

FIG. 8 is a cross-sectional view schematically showing a formation embodiment of a solidified layer by hybrid systems

FIG. 9 is a cross-sectional view schematically showing a three-dimensional shaped object having a portion for a gas vent therein.

FIG. 10 is a cross-sectional view schematically showing a three-dimensional shaped object having a flow path for cooling media therein.

FIGS. 11A-11C are cross-sectional views schematically illustrating a laser-sintering/machining hybrid process for a selective laser sintering method.

FIG. 12 is a perspective view schematically illustrating a construction of a laser-sintering/machining hybrid machine.

FIG. 13 is a flow chart of general operations of a laser-sintering/machining hybrid machine.

### MODES FOR CARRYING OUT THE INVENTION

The present invention will be described in more detail with reference to the accompanying drawings. It should be noted that configurations/forms and dimensional proportions in the drawings are merely for illustrative purposes, and thus not the same as those of the actual parts or elements.

The term “powder layer” as used in this description means a “metal powder layer made of a metal powder” or “resin powder layer made of a resin powder”, for example. The term “predetermined portion of a powder layer” as used herein substantially means a portion of a three-dimensional shaped object to be manufactured. As such, a powder present in such predetermined portion is irradiated with a light beam, and thereby the powder undergoes a sintering or a melting and subsequent solidification to form a shape of a three-dimensional shaped object. Furthermore, the term “solidified layer” substantially means a “sintered layer” in a case where the powder layer is a metal powder layer, whereas term “solidified layer” substantially means a “cured layer” in a case where the powder layer is a resin powder layer.

The directions of “upper” and “lower”, which are directly or indirectly used herein, are ones based on a positional relationship between a base plate and a three-dimensional shaped object. The side in which the manufactured three-dimensional shaped object is positined with respect to the base plate is “upper”, and the opposite direction thereto is “lower”. The “vertical direction” described herein substantially means a direction in which the solidified layers are stacked, and corresponds to “upper and lower direction” in drawings. The “horizontal direction” described herein substantially means a direction vertical to the direction in which the solidified layers are stacked, and corresponds to “right to left direction” in drawings.

### [Selective Laser Sintering Method]

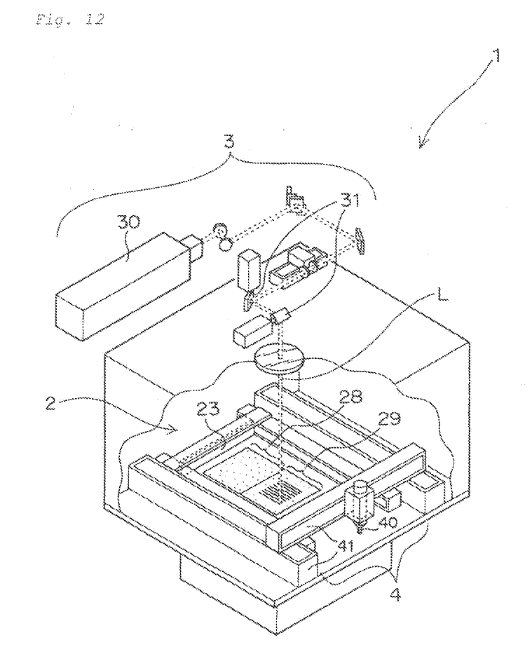

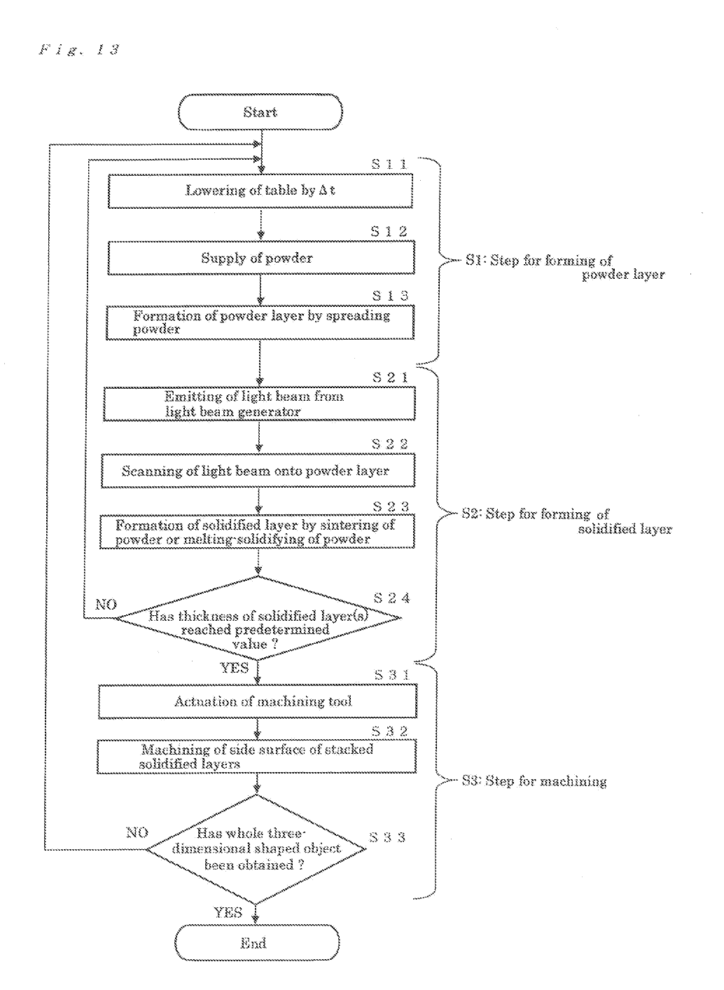

First of all, a selective laser sintering method, on which an embodiment of the manufacturing method of the present invention is based, will be described. By way of example, a laser-sintering/machining hybrid process wherein a machining is additionally carried out in the selective laser sintering method will be especially explained. FIGS. 11A-11C schematically show a process embodiment of the laser-sintering/machining hybrid. FIGS. 12 and 13 respectively show major constructions and operation flow regarding a metal laser sintering hybrid milling machine for enabling an execution of a machining process as well as the selective laser sintering method.

As shown in FIG. 12, the laser-sintering/milling hybrid machine 1 is provided with a powder layer former 2, a light-beam irradiator 3, and a machining means 4.

The powder layer former 2 is a means for forming a powder layer with its predetermined thickness through a supply of powder (e.g., a metal powder or a resin powder). The light-beam irradiator 3 is a means for irradiating a predetermined portion of the powder layer with a light beam “L”. The machining means 4 is a means for milling the side surface of the stacked solidified layers, i.e., the surface of the three-dimensional shaped object.

As shown in FIGS. 11A-11C, the powder layer former 2 is mainly composed of a powder table 25, a squeegee blade 23, a forming table 20 and a base plate 21. The powder table 25 is a table capable of vertically elevating/descending in a “storage tank for powder material” 28 whose outer periphery is surrounded with a wall 26. The squeegee blade 23 is a blade capable of horizontally moving to spread a powder 19 from the powder table 25 onto the forming table 20, and thereby forming a powder layer 22. The forming table 20 is a table capable of vertically elevating/descending in a forming tank 29 whose outer periphery is surrounded with a wall 27. The base plate 21 is a plate for a three-dimensional shaped object. The base plate is disposed on the forming table 20 and serves as a platform of the three-dimensional shaped object.

As shown in FIG. 12, the light-beam irradiator 3 is mainly composed of a light beam generator 30 and a galvanometer mirror 31. The light beam generator 30 is a device for emitting a light beam “L”. The galvanometer mirror 31 is a means for scanning an emitted light beam “L” onto the powder layer, i.e., a scan means of the light beam “L”.

As shown in FIG. 12, the machining means 4 is mainly composed of an end mill 40 and an actuator 41. The end mill 40 is a machining tool for milling the side surface of the stacked solidified layers, i.e., the surface of the three-dimensional shaped object. The actuator 41 is a driving means for allowing the end mill 40 to move toward the position to be machined.

Operations of the laser sintering hybrid milling machine 1 will now be described in detail. As can be seen from the flowchart of FIG. 13, the operations of the laser sintering hybrid milling machine 1 are mainly composed of a powder layer forming step (S1), a solidified layer forming step (S2), and a machining step (S3). The powder layer forming step (S1) is a step for forming the powder layer 22. In the powder layer forming step (S1), first, the forming table 20 is descended by Δt (S11), and thereby creating a level difference Δt between an upper surface of the base plate 21 and an upper-edge plane of the forming tank 29. Subsequently, the powder table 25 is elevated by Δt, and then the squeegee blade 23 is driven to move from the storage tank 28 to the forming tank 29 in the horizontal direction, as shown in FIG. 11A. This enables a powder 19 placed on the powder table 25 to be spread onto the base plate 21 (S12), while forming the powder layer 22 (S13). Examples of the powder for the powder layer include a “metal powder having a mean particle diameter of about 5 μm to 100 μm” and a “resin powder having a mean particle diameter of about 30 μm to 100 μm (e.g., a powder of nylon, polypropylene, ABS or the like”. Following this step, the solidified layer forming step (S2) is performed. The solidified layer forming step (S2) is a step for forming a solidified layer 24 through the light beam irradiation. In the solidified layer forming step (S2), a light beam “L” is emitted from the light beam generator 30 (S21). The emitted light beam “L” is scanned onto a predetermined portion of the powder layer 22 by means of the galvanometer mirror 31 (S22). The scanned light beam can cause the powder in the predetermined portion of the powder layer to be sintered or be melted and subsequently solidified, resulting in a formation of the solidified layer 24 (S23), as shown in FIG. 11B. Examples of the light beam “L” include carbon dioxide gas laser, Nd:YAG laser, fiber laser, ultraviolet light, and the like.

The powder layer forming step (S1) and the solidified layer forming step (S2) are alternately repeated. This allows a plurality of the solidified layers 24 to be integrally stacked with each other, as shown in FIG. 11C.

When the thickness of the stacked solidified layers 24 reaches a predetermined value (S24), the machining step (S3) is initiated. The machining step (S3) is a step for milling the side surface of the stacked solidified layers 24, i.e., the surface of the three-dimensional shaped object. The end mill 40 is actuated in order to initiate an execution of the machining step (S31). For example, in a case where the end mill 40 has an effective milling length of 3 mm, a machining can be performed with a milling depth of 3 mm. Therefore, supposing that “Δt” is 0.05 mm, the end mill 40 is actuated when the formation of the sixty solidified layers 24 is completed. Specifically, the side face of the stacked solidified layers 24 is subjected to the surface machining (S32) through a movement of the end mill 40 driven by the actuator 41. Subsequent to the surface machining step (S3), it is judged whether or not the whole three-dimensional shaped object has been obtained (S33). When the desired three-dimensional shaped object has not yet been obtained, the step returns to the powder layer forming step (S1). Thereafter, the steps S1 through S3 are repeatedly performed again wherein the further stacking of the solidified layers 24 and the further machining process therefor are similarly performed, which eventually leads to a provision of the desired three-dimensional shaped object.

### [Manufacturing Method of the Present Invention]

An embodiment of the present invention is characterized by a stacking of the solidified layers in the selective laser sintering method.

Specifically, upon the manufacturing of the three-dimensional shaped object in accordance with the selective laser sintering method, the three-dimensional shaped object is manufactured such that it has a heat source element therein and also has a surface in a form of a concavity-convexity. Especially, the three-dimensional shaped object is manufactured such that a main surface/a principle surface of the heat source element and the surface of the concavity-convexity of the three-dimensional shaped object have the same shape as each other. Thus, the manufacturing method of the present invention is characterized in that a shape of the heat source element in the three-dimensional shaped object and a shape of the surface of the three-dimensional shaped object have a correlation with each other.

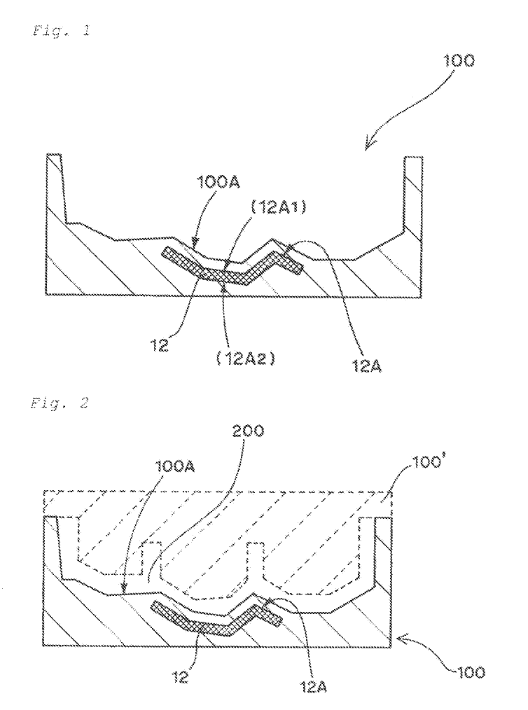

FIG. 1 shows a three-dimensional shaped object 100 to be obtained by the manufacturing method according to an embodiment of the present invention. The three-dimensional shaped object 100 has a heat source element 12 therein and also has a surface 100A in a form of a concavity-convexity. As shown in FIG. 1, a main surface 12A of the heat source element 12 and the surface 100A of the concavity-convexity of the three-dimensional shaped object 100 have the same shape as each other. In the manufacturing method according to an embodiment of the present invention, the three-dimensional shaped object 100 is manufactured such that the surface 100A of the three-dimensional shaped object 100 and a contour of the main surface 12A of the heat source element 12 in the three-dimensional shaped object have a correlated shape with each other.

The phrase “heat source element” as used herein indicates a thermal source for serving to increase a temperature of the three-dimensional shaped object 100 or to keep the temperature thereof. In a case when the three-dimensional shaped object 100 is used as a metal mold, the “heat source element” indicates an element having a heat effect on a raw material for the molding in a mold cavity. Specific examples of the heat source element include a heater and a flow path for heating media. Please note that the term “heat” is used herein in terms of an embodiment wherein the temperature of the three-dimensional shaped object 100 is increased or maintained by a thermal provision. The phrase “main surface of the heat source element” as used herein substantially means a surface having a wide range of area in the heat source element. FIG. 1 shows a main surface 12A of the heat source element 12, the main surface being composed of an upper side-main surface 12A₁ and a lower side-main surface 12A₂. In this regard, the upper side-main surface 12A₁ may at least have the same shape as that of the surface 100A in the form of the concavity-convexity of the three-dimensional shaped object 100 in the present invention. As shown in FIG. 1, it is preferable that both of the upper side-main surface 12A₁ and the lower side-main surface 12A₂ of the heat source element 12a have the same shape as that of the surface 100A in the form of the concavity-convexity of the three-dimensional shaped object 100.

The phrase “same shape” as used herein means a state that a contour of the main surface 12A of the heat source element 12 and the surface 100A of the three-dimensional shaped object 100 have the same shape as each other. The term “same” means substantial same and thus a use of the term “same” is possible even in an embodiment wherein an inevitable or incidental slight offset is provided between shapes to be compared. The main surface 12A of the heat source element 12 does not need to have the same shape as that of whole surface 100A in the form of the concavity-convexity of the three-dimensional shaped object 100. The main surface 12A of the heat source element 12 may have the same shape as that of at least a part of the surface 100A (See FIG. 1).

The phrase “formation of the surface in the form of the concavity-convexity” as used herein means an embodiment wherein a formation of the solidified layer is performed such that an outer surface of the three-dimensional shaped object locally has a different hight level. Thus, the phrase “the surface in the form of the concavity-convexity” as used herein means the outer surface of the three-dimensional shaped object locally having the different hight level. When it is assumed that the three-dimensional shaped object 100 is used as a metal mold, the surface 100A in the form of the concavity-convexity corresponds to a so called “cavity forming surface” (FIG. 2). FIG. 2 shows that a mold cavity 200 is provided, the mold cavity 200 being formed by a combination of one three-dimensional shaped object 100 to be used as “cavity side mold” and another three-dimensional shaped object 100′ to be used as “core side mold”.

In a case when the three-dimensional shaped object 100 to be obtained by the manufacturing method of the present invention is used as the metal mold for the molding, it is possible to more uniformly transfer a heat arising from the heat source element 12 which is buried in the metal mold. Especially, the more uniform heat transfer from the heat source element 12 to the cavity forming surface is possible. In the case when the three-dimensional shaped object 100 to be obtained by the manufacturing method of the present invention is used as the metal mold, the more uniform heat transfer from the heat source element 12 allows a prevention of a disadvantageous local earlier cooling of the raw material for the molding filled in the mold cavity 200, which leads to a more sufficient pressurization of the raw material for the molding in the mold cavity 200. Accordingly, a reduction of a molding defect is possible. For example, an occurrence of weld line can reduced, which allows a reduction of a shape accuracy of a molded article to be prevented. Furthermore, the more sufficient pressurization of the raw material for the molding in the mold cavity contributes to a close contact of the raw material for the molding to the cavity forming surface of the metal mold by using a larger pressure. Thus, a transcriptional accuracy of the mold in the molded article to be finally obtained can be increased.

In the manufacturing method according to an embodiment of the present invention, it is preferable that a spaced distance is rendered constant, the spaced distance being defined between the main surface 12A (especially, upper side main surface 12A₁) of the heat source element 12 and the surface 100A in the form of the concavity-convexity (see FIG. 1). Specifically, the heat source element 12 is provided such that it has the main surface 12A (especially, upper side main surface 12A₁) having its contour shape to which a contour shape of the surface 100A of the three-dimensional shaped object 100 is offset. The phrase “a constant spaced distance” as used herein means a state that a normal line has the same length even in any portion, the normal line being a line connecting the main surface 12A between the surface 100A of the concavity-convexity which are opposite/faced to each other. Specifically, the normal line between the main surface 12A of the heat source element 12 and the surface 100A of the three-dimensional shaped object 100 has the same length even in any portion therebetween. The normal line having the same length allows a transfer of a more uniform heat from the heat source element 12 to the mold cavity along an extension direction of the main surface 12A of the heat source element 12 upon the using of the three-dimensional shaped object 100 as the metal mold. Thus, it is possible to effectively prevent the reduction of the shape accuracy in the molded article to be finally obtained by using the metal mold.

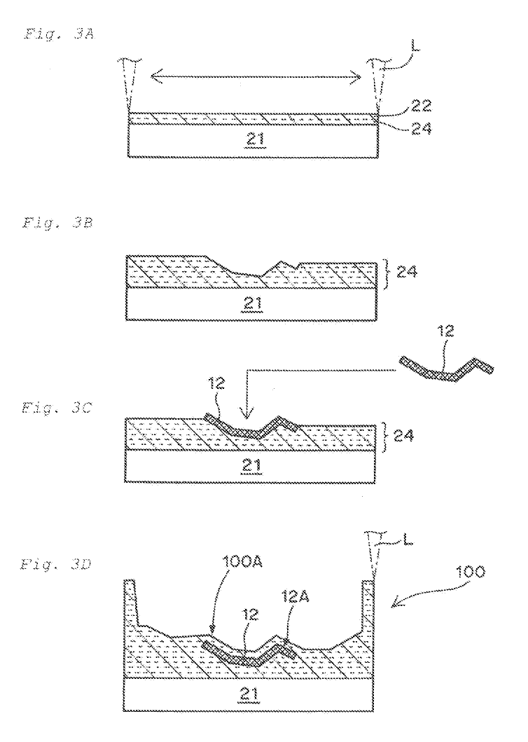

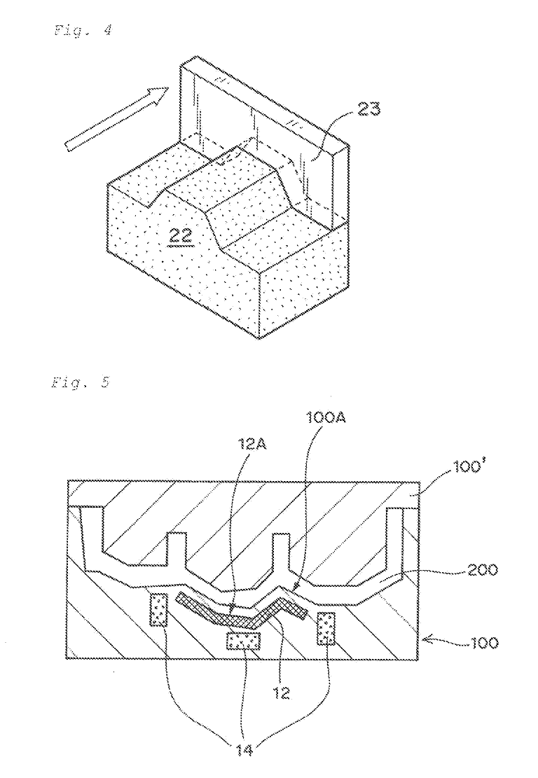

The manufacturing method according to an embodiment of the present invention will be described hereinafter with reference to FIGS. 3A-3D. FIGS. 3A-3D show that the heat source element 12 is provided in a middle of the stack of the solidified layers 24 by the selective laser sintering method in the manufacturing method according to an embodiment of the present invention. As shown in FIGS. 3C-3D, a heater is used as the heat source element 12.

As shown in FIGS. 3A and 3B, a formation of the powder layer 22 on the base plate 21 is performed and subsequently the powder layer 22 is irradiated with the light beam L to form the solidified layer 24 from the powder layer 22. The stack of the solidified layers 24 is performed by the alternate repetition of the powder-layer forming and the solidified-layer forming. As shown in FIG. 3C, the heater as the heat source element 12 is provided in the middle of the stack of the solidified layers 24. Specifically, the formations of the powder layer and the solidified layer are once stopped, and subsequently the heater as the heat source element 12 is provided on the already formed solidified layer 24. As can be seen from FIG. 3C, it is preferable that powders not contributing to the solidified layer forming are once removed and subsequently the heater as the heat source element 12 is provided. Upon the provision of the heat source element 12, a so called “CAE Analaysis” (i.e., Computer Aided Engineering Analaysis) may be used and thus the heat source element 12 can be provided at a pre-specified position.

It is preferable that the heat source element 12 to be provided has the main surface having the same shape as that of the surface of the concavity-convexity of the three-dimensional shaped object to be finally obtained. It is preferable that, upon the use of the heater as the heat source element 12, “a heat generation surface of the heater” has the same shape as that of the surface of the concavity-convexity of the three-dimensional shaped object to be finally obtained, the heat generation surface corresponding to the main surface of the heat source element 12. In other words, it is preferable that a main surface of a heat generation portion of the heater has the same shape as that of the surface of the concavity-convexity of the three-dimensional shaped object. While not being limited to a specific embodiment, the heat generation portion of the heater may be formed in advance by a thermal spraying method for example.

As can be seen from FIG. 3C, it is preferable that the surface of the stacked body of the solidified layers 24 for disposing the heat source element 12 thereon has the same shape as that of the contour of the heat source element 12. Thus, it is possible to bury the heat source element 12 in the three-dimensional shaped object 100 to be finally obtained without any clearance. Furthermore, the main surface 12A of the heat source element 12 and the surface 100A of the concavity-convexity of the three-dimensional shaped object to be finally obtained have the same shape as each other (see FIG. 3D). This means that the surface of the stacked body of the solidified layers 24 for disposing the heat source element 12 thereon has the same shape as that of the surface 100A of the concavity-convexity of the three-dimensional shaped object 100.

While not being limited to the above embodiment, the surface of “the stacked body of the solidified layers” for disposing the heat source element thereon may have a shape differing from the contour shape of the heat source element while not being shown in Figure, which allows a provision of a clearance between “the solidified layer as a composition element of the three-dimensional shaped object” and “the heat source element” in the three-dimensional shaped object. In a case of a use of the heater as the heat source element, a condition of a heat generation of the heater may result in a strain or a deformation thereof. The clearance allows a space for accepting the strain or the deformation of the heater to be provided, which makes it possible to effectively prevent a deformation of the three-dimensional shaped object upon the use thereof.

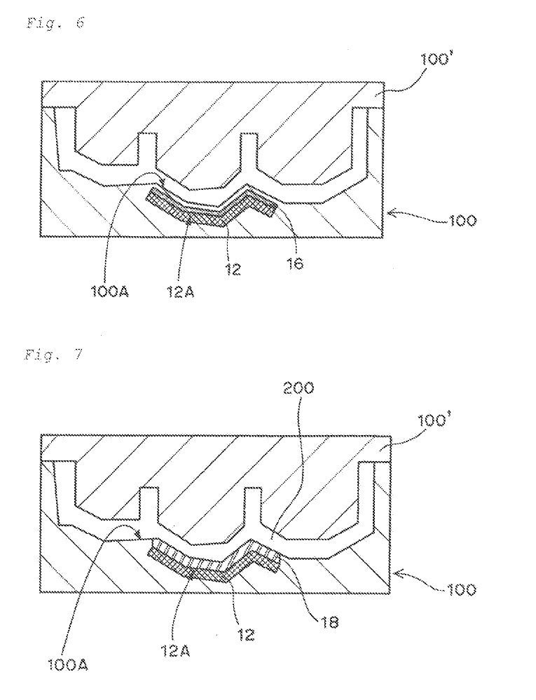

Subsequent to a completion of the disposition of the heater as the heat source element 12, the selective laser sintering method is continuously performed. The selective laser sintering method to be used after the disposition of the heater is the same method as that used before the disposition of the heater. The stack of the solidified layers 24 is performed by the alternate repetition of the powder-layer forming and the solidified-layer forming. Please note that there is a possibility that a formation of a new powder layer is difficult after the disposition of the heat source element 12 due to “the main surface of the concavity-convexity of the heat source element 12” and “an once removal of the powders”. In such a case, a squeegee blade 23 shown in FIG. 4 may be used for the formation of the powder layer. Specifically, it may be possible to use the squeegee blade 23 including a portion locally having a hight different from that of another portion thereof. A use of such the squeegee blade 23 allows a proper formation of a new powder layer on the stacked body of the solidified layers after the disposition of the heat source element 12. A use of the squeegee blade 23 which is shape changeable is preferable, and thus an proper formation of the powder layer having a desired shape is possible. Furthermore, the squeegee blade 23 including the portion locally having the hight different from that of another portion thereof may be used before the disposition of the heat source element. A use of such squeegee blade 23 contributes to a formation of the stacked body on which the heat source element 12 is disposed, the stacked body being composed of the solidified layers 24 having its surface of the concavity-convexity.

Finally, the stack of the solidified layers is performed such that at least a part of the surface of the three-dimensional shaped object 100 has the same shape as that of the main surface 12A of the heat source element 12. In an embodiment shown in FIG. 3D, the surface of the three-dimensional shaped object corresponds to a top surface thereof. Accordingly, a desired three-dimensional shaped object 100 can be obtained. Specifically, it is possible to obtain the three-dimensional shaped object 100 having its surface 100A in the form of the concavity-convexity and also having the heat source element 12 therein whose main surface 12A has the same shape as that of the surface 100A in the form of the concavity-convexity.

Hereinafter, the heater to be used as the heat source element 12 will be described. The heater may include a sheet heater and a coil heater, for example. A use of the sheet heater is preferable in that, due to the sheet heater “in a form of a sheet”, the sheet heater has a relatively large main surface and thus it is easy to form the main surface thereof having the same shape as that of the surface 100A of the concavity-convexity. An element such as a piezo element and a peltier element may be used as the heat source element 12.

FIGS. 3A-3D show the three-dimensional shaped object having the heat source element 12 buried by the “disposition” of the heater in the middle of the stacking of the solidified layers 24 on a condition of a use of the heater as the heat source element 12. While not being limited to the heater, the heat source element 12 maybe a flow path for heating media. In such a case, a “formation” of the flow path as the heat source element 12 in the middle of the stacking of the solidified layers 24 results in a provision of the heat source element 12 in the three-dimensional shaped object 100.

Especially, in the manufacturing method according to an embodiment of the present invention, it is preferable that a wall surface forming the flow path for the heat media to be formed in the three-dimensional shaped object and the surface in the form of the concavity-convexity have the same shape as each other (not shown in figure). Thus, upon the use of the three-dimensional shaped object as the metal mold, it is possible to more uniformly transfer a heat from the flow path for the heating media to the cavity forming surface provided in the metal mold.

The phrase “flow path for the heating media” means a flow path for flowing the heating media such as fluid in the three-dimensional shaped object. Thus, the flow path for the heating media has a hollow portion in the three-dimensional shaped object. In a case of a use of the flow path for the heating media as the heat source element, the flow path for the heating media results from a non-irradiated portion to be obtained by not solidifying a local region in the middle of the stack of the solidified layers to be provided by the alternate repetition of the powder-layer forming and the solidified-layer forming by the selective laser sintering method. The non-irradiated portion corresponds to a portion being not irradiated with the light beam at “a formation region of the three-dimensional shaped object” which is the predetermined region of the powder layer. Thus, “powders not contributing to a formation of the solidified layer” remain in the non-irradiated portion after an irradiation by using the light beam. The flow path for the heating media results from a removal of the remaining powders from the three-dimensional shaped object. Especially, in the present invention, the flow path for the heating media is formed such that its wall surface, i.e., amain surface of the non-irradiated portion has the same shape as that of the surface in the form of the concavity-convexity of the three-dimensional shaped object to be finally obtained. It is preferable that a predetermined portion of the wall surface which is proximal to the surface of the concavity-convexity of the three-dimensional shaped object has the same shape as that of the surface of the concavity-convexity.

Furthermore, the heat source element may be a part made of a high heat conductive material. The part has a high heat conductivity, and thus it is possible to transfer a heat from an outside into the three-dimensional object via the high heat conductive part. This embodiment does not correspond to an embodiment wherein the heat source element itself such as the heater and the flow path for the heating media disposed in the three-dimensional shaped object substantially serves as a heat generation source. This embodiment corresponds to an embodiment wherein the heat source element serves as a “heat conducting part” for conducting a heat generated by the heat generation source from the outside into the three-dimensional shaped object. It is preferable that the heat source element to be used as the heat conducting part, i.e., the part of the high heat conductive material is composed of a metal material. It is preferable that cupper based material is used as the metal material. A material comprising beryllium copper can be exemplified as the copper based material.

Typical embodiments have been described to promote an understanding of the present invention hereinbefore. The manufacturing method of the present invention can adopt a variety of embodiments.

(Formation of Heat-Insulating Porous Region)

In the manufacturing method according to an embodiment of the present invention, a heat-insulating porous region may be formed around the heat source element 12 in the three-dimensional shaped object 100 as shown in FIG. 5.

The phrase “heat-insulating porous region” means a region having a lower solidified density in which micro pores are formed. Thus, the phrase “heat-insulating porous region” means a region having a relatively low heat conductivity, i.e., a region which can make the heat transfer difficult for a heat insulation. The provision of the heat-insulating porous region 14 in the three-dimensional shaped object 100 allows the heat transfer from the heat source element 12 to be more properly controlled. As shown in FIG. 5, a formation of the heat-insulating porous region 14 around the heat source element 12 allows the heat transfer from the heat source element 12 to the surface 100A of the concavity-convexity to be more promoted. In a case of the use of the three-dimensional shaped object 100 as the metal mold, a heating of the raw material for the molding provided in the mold cavity 200 can be more promoted. It is preferable that the heat-insulating porous region 14 around the heat source element 12 is positioned at regions other than region between the heat source element 12 and the surface 100A of the concavity-convexity. Furthermore, the number of the heat-insulating porous region 14 is not limited to one. A provision of a plurality of the heat-insulating porous regions 14 may be possible.

The heat-insulating porous region 14 has the solidified density of 40%-80% for example. Such a lower solidified density results from (1) a reduction of output energy of the light beam, (2) an increase of a scan speed of the light beam, (3) an extension of a scan pitch of the light beam, and (4) an enlargement of a spot diameter of the light beam for example. The phrase “solidified density (%)” described herein substantially means a solidified sectional density (an occupation-ratio of a solidified material) determined by an image processing of a sectional photograph of the three-dimensional shaped object. Image processing software for determining the solidified sectional density is Scion Image ver. 4.0.2 (freeware made by Scion). In such case, it is possible to determine a solidified sectional density ρₛ from the below-mentioned equation 1 by binarizing a sectional image into a solidified portion (white) and a vacancy portion (black), and then counting all picture element numbers Pxₐₗₗ of the image and picture element number Px_{white} of the solidified portion (white).

$${ρ}_{S} = \frac{{Px}_{white}}{{Px}_{all}} \times 100 ( \% ) \qquad [ Equation 1 ]$$

(Provision of Heat Source Element-Protection Part)

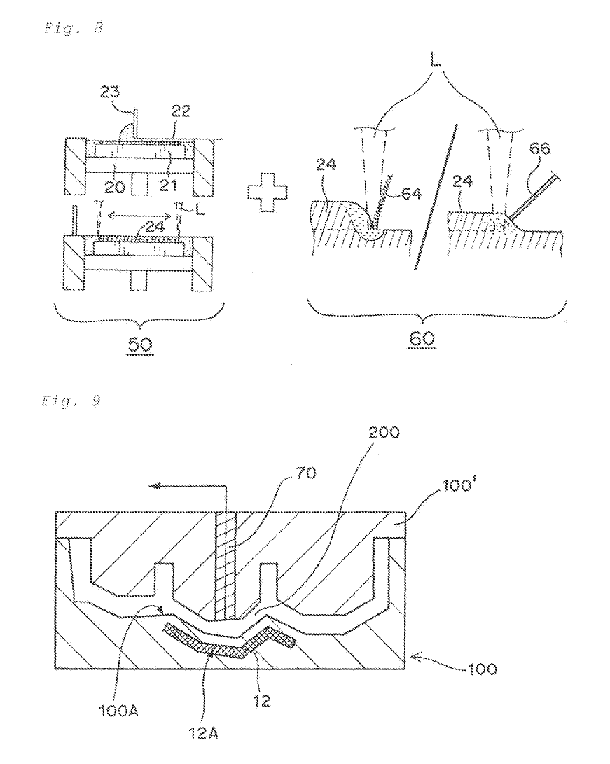

In the manufacturing method according to an embodiment of the present invention, a protection part 16 for the heat source element may be provided in the three-dimensional shaped object 100, the protection part 16 being positioned on the main surface 12A of the heat source element 12 (see FIG. 6). Especially, when the heater is used as the heat source element 12, it is preferable that the protection part 16 for the heat source element is disposed on the heat generation surface of the heater.

When the heater is used as the heat source element 12, the disposition of the heater is performed in the middle of the stacking of the solidified layers, and subsequently the alternate repetition of the powder-layer forming and the solidified-layer forming is performed. In this regard, when the powder layer formed on the heater is irradiated with the light beam to form the solidified layer, the heater as well as the powder layer is subjected to the light beam irradiation, and thus a damage of the heater may occur. Thus, it is preferable that the heat source element-protection part 16 which serves to protect the heat source element 12 is disposed on the main surface 12A of the heat source element 12, i.e., the heat generation surface of the heater. The disposition of the heat source element-protection part 16 allows an avoidance of an occurrence of the damage of the heat source element 12 due to the light beam irradiation at a subsequent step, which can make it possible to maintain a desired property of the heat source element 12.

It is preferable that the heat source element-protection part 16 and the heat source element 12 have a close contact with each other as shown in FIG. 6. The disposition of the heat source element-protection part 16 is preferable such that the main surface of the protection part 16 has the same contour shape as that of the main surface 12A (especially upper side main surface) of the heat source element 12. In such a case, a clearance does not occur between the heat source element-protection part 16 and the heat source element 12, and thus it is possible to avoid a technical problem that the heat source element 12 is directly irradiated with the light beam. The avoidance of the direct irradiation allows an occurrence of the damage of the heat source element 12 due to the light beam irradiation to be more effectively avoided. Furthermore, the heat source element-protection part 16 having in advance the main surface of a desired contour shape may be used. A disposition of such a heat source element-protection part 16 on the heat source element 12 allows the close contact of the heat source element-protection part 16 with the heat source element 12.

While not being limited to a specific embodiment, it is preferable that the heat source element-protection part 16 is composed of a metal material. For example, the metal material may be iron based material, copper based material or aluminium based material. A use of the iron based material which is relatively hard metal material is preferable in terms of an increase of a hardness degree of the three-dimensional shaped object. A use of the copper based material which has relatively high heat conductivity is preferable in terms of an increase of a property of a heat transfer of the three-dimensional shaped object. A use of the aluminium based material which has relatively low density is preferable to make the three-dimensional shaped object lighter.

(Provision of Heat Transfer Part)

In the manufacturing method according to an embodiment of the present invention, a heat transfer part 18 may be provided in the three-dimensional shaped object 100 such that the heat transfer part 18 is positioned at a region between the main surface 12A of the heat source element 12 and the surface 100A of the three-dimensional shaped object 100 (see FIG. 7).

Especially, it is preferable that the heat transfer part 18 having a high heat conductivity is positioned at a region between “the main surface 12A (especially upper surface) of the heat source element 12” and “the surface 100A of the three-dimensional shaped object 100”. It may be possible to use the heat transfer part 18 composed of a material of a heat conductivity higher than that of a material of the three-dimensional shaped object 100. The use of the heat transfer part 18 allows the heat transfer from the heat source element 12 to the surface 100A of the concavity-convexity to be promoted. Thus, upon the use of the three-dimensional shaped object 100 as the metal mold, it is possible to promote the heating of the raw material for the molding in the mold cavity 200 as shown in FIG. 7.

It is preferable that the heat transfer part 18 is composed of a metal material. As the metal material, a use of copper based material which has a higher heat conductivity is preferable. A material comprising beryllium copper can be exemplified as the copper based material. It is preferable that the heat transfer part 18 is disposed such that it has the same contour shape as that of the main surface 12A (especially upper side main surface) of the heat source element 12 (see FIG. 7). In other words, it is preferable that the heat transfer part 18 is disposed such that the heat transfer part 18 and the heat source element 12 have a close contact with each other. The close contact disposition allows the heat arising from the heat source element 12 to be more effectively transferred to the surface 100A of the concavity-convexity. Furthermore, the heat transfer part 18 may be provided such that a main surface (especially upper side main surface) of the heat transfer part 18 constitutes a part of the surface 100A of the concavity-convexity of the three-dimensional shaped object 100 (see FIG. 7).

(Formation of Solidified Layer by Hybrid Systems)

In the manufacturing method according to an embodiment of the present invention, the formation of the solidified layer may be performed in combination with a method other than the selective laser sintering method. Specifically, the formation of the solidified layer may be performed by hybrid systems which combine the selective laser sintering method with a method for the solidified layer other than the selective laser sintering method.

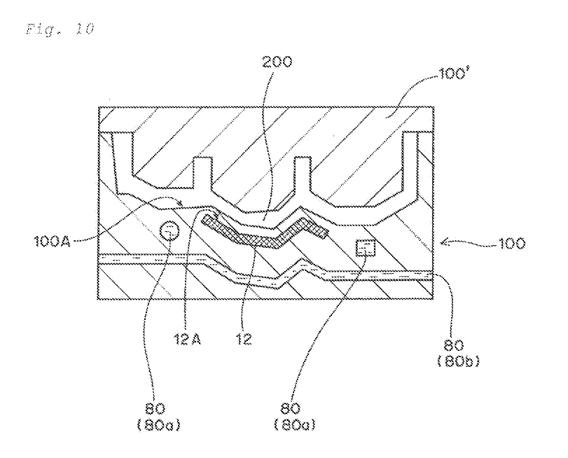

Specifically, as shown in FIG. 8, the formation of the solidified layer 24 may be formed by a hybrid of combined systems of “an after irradiation system 50” and “a simultaneous irradiation system 60”, the after irradiation system 50 being a system that the light beam irradiation is performed after the formation of the powder layer, the simultaneous irradiation system 60 being a system that the light beam irradiation is performed while a raw material is supplied. More specifically, the after irradiation system 50 is a system that the powder layer 22 is irradiated with the light beam L to form the solidified layer 24 after the formation of the powder layer 22. The after irradiation system 50 corresponds to the selective laser sintering method. The simultaneous irradiation system 60 is a system that the supply of the raw material such as a powder 64 or a welding material 66 and the light beam irradiation are substantially simultaneously performed to form the solidified layer 24. The after irradiation system 50 can make a shape accuracy relatively higher, whereas it may make a formation time for the solidified layer relatively longer. In contrast, the simultaneous irradiation system 60 may make a shape accuracy relatively lower, whereas it can make a formation time for the solidified layer relatively shorter. Thus, a proper combination of “the after irradiation system 50” with “the simultaneous irradiation system 60” which have contradictory features respectively can contribute to a more effective manufacturing of the three-dimensional shaped object. More specifically, the hybrid systems complement an advantage and a disadvantage of “the after irradiation system 50” and those of “the simultaneous irradiation system 60” with each other, which makes it possible to manufacture the three-dimensional shaped object having a desired shape accuracy for a shorter time.

Especially, the present invention is characterized by the contour shape of the heat source element and the surface of the concavity-convexity of the three-dimensional shaped object, and thus its shape accuracy is required. Thus, a region at which the request of the shape accuracy exists may be formed by “the after irradiation system 50”, and another region at which the request of the shape accuracy does not exist may be formed by “the simultaneous irradiation system 60”. More specifically, with respect to a formation of the solidified layer region around the heat source element (e.g., the solidified layer region on which the heat source element is provided) and the solidified layer region of the surface of the concavity-convexity of the three-dimensional shaped object, “the after irradiation system 50” may be used. Whereas, with respect to a formation of another solidified layer region other than the above regions, “the simultaneous irradiation system 60” may be used. Thus, it is possible to manufacture the three-dimensional shaped object having a desired shape accuracy for a shorter time. The heat source element-protection part or the heat transfer part as described above may be provided by “the simultaneous irradiation system” mainly.

(Three-Dimensional Shaped Object of Present Invention)

A three-dimensional shaped object of the present invention is obtained by the above manufacturing method. Thus, the three-dimensional shaped object of the present invention is composed of the stack of the solidified layers to be obtained by irradiating the powder layer with the light beam. As shown in FIG. 1, the three-dimensional shaped object 100 is characterized in that it has a surface 100A in a form of a concavity-convexity, and a main surface 12A of a heat source element 12 and the surface 100A of the concavity-convexity have the same shape as each other, the heat source element 12 being provided in the three-dimensional shaped object 100. Thus, a provision of a more proper heat property is possible. Especially, in a case of a use of the three-dimensional shaped object as a metal mold, a more uniform heat transfer from the heat source element to a cavity forming surface is possible.

With regard to the three-dimensional shaped object to be used as the metal mold, the three-dimensional shaped object of the present invention can be used as the metal mold for a molding especially. The phrase “molding” means a general molding for obtaining a molded article of such a resin, and also means an injection molding, an extrusion molding, a compression molding, a transfer molding or a blow molding for example. The metal mold for the molding shown in FIG. 1 corresponds to a so called “cavity side”, and the three-dimensional shaped object 100 of the present invention may correspond to a “core side” metal mold for the molding.

The three-dimensional shaped object 100 to be used as the metal mold according to a preferable embodiment of the present invention has the heat source element 12 such as a heater or a flow path for heating media therein (see FIG. 1). Especially, it is preferable that the three-dimensional shaped object 100 according to an embodiment of the present invention has a spaced distance between the main surface 12A of the heat source element 12 and the surface 100A of the concavity-convexity (see FIG. 1). Specifically, it is preferable that the heat source element 12 has a contour shape to which a part of the surface 100A of the three-dimensional shaped object 100 is offset. For example, the spaced distance between the main surface 12A of the heat source element 12 and the surface 100A of the concavity-convexity of the three-dimensional shaped object 100 may be about 0.5-20 mm. Especially, the main surface 12A may correspond to an upper surface 12A₁ more proximal to the surface 100A of the concavity-convexity. In a case of a use of such a three-dimensional shaped object 100 as the metal mold, the constant spaced distance allows a much more uniform heat transfer from the heat source element 12 to the cavity forming surface (see FIG. 2). Thus, it is possible to more effectively prevent a reduction of a shape accuracy in a molded article to be finally obtained by the metal mold.

A variety of specific features of the three-dimensional shaped object, modified embodiments thereof and technical effects thereon have been described in the above [manufacturing method of present invention]. Thus, these descriptions are omitted in view of an avoidance of overlapping portions.

### A Variety of Specific Embodiments of Three Dimensional Shaped Object to be Used as Metal Mold

A variety of specific embodiments of the three dimensional shaped object to be used as metal mold according to an embodiment of the present invention will be described hereinafter.

The three-dimensional shaped object to be manufactured by the selective laser sintering method may have a gas vent portion therein. As shown in FIG. 9, another three-dimensional shaped object 100′ may have the gas vent portion 70, the another object 100′ being used in combination with the three-dimensional shaped object 100. When a mold cavity 200 is filled with a melt raw material for a molding, a gas arising from the raw material for the molding may occur. The gas is easy to remain in the mold cavity 200. Thus, it is preferable that the three-dimensional shaped object 100′ has the gas vent portion 70 therein to be able to remove the gas arising from the filled raw material for the molding. For example, a porous region having a lower solidified density can be provided as the gas vent portion 70. It is preferable that the gas vent portion 70 in a form of porous has a solidified density for preventing a flow-out of the raw material for the molding from the mold cavity 200 and for being capable of adequately discharging the gas to an outside. While not being limited to a specific embodiment, it is preferable that the gas vent portion 70 in the form of the porous has its solidified density of about 40-80%. Such the gas vent portion 70 in the form of the porous results from the same process as that of the formation of the above “heat-insulating porous region”. Such the formation of the gas vent portion 70 in the form of the porous results from (1) the reduction of output energy of the light beam, (2) the increase of the scan speed of the light beam, (3) the extension of the scan pitch of the light beam, and (4) the enlargement of the spot diameter of the light beam for example.

In an embodiment shown in FIG. 9, the gas vent portion 70 in the form of the porous is provided in another metal mold different from one metal mold having the heat source element 12 therein, the one metal mold being the three-dimensional shaped object 100 to be used as a cavity side metal mold, the another metal mold being the three-dimensional shaped object 100′ to be used as a core side metal mold. As shown in FIG. 9, the gas vent portion 70 in the form of the porous may be provided such that the gas vent portion 70 and the heat source element 12 are opposed to each other at a point in time after the mold clamping. Especially, it is preferable that the gas vent portion 70 in the form of the porous is provided such that it penetrates from another mold's surface serving as the cavity forming surface to an outer surface thereof via an internal portion of another mold. Such the gas vent portion 70 in the form of the porous allows an avoidance of the remaining of a gas arising from the raw material for the molding in the mold cavity 200 and also an effective discharge of the gas to the outside. Thus, a transcriptional accuracy of the mold in the molded article to be finally obtained can be more increased due to the above technical effects regarding the avoidance of the gas remaining and the effective discharge of the gas as well as the technical effects by the heat property of the heat source element 12 of the object 100. Without being limited to the embodiment of FIG. 9, both of the gas vent portion in the form of the porous and the heat source element may be provided in either one of “the core side metal mold” and “the cavity side metal mold”.

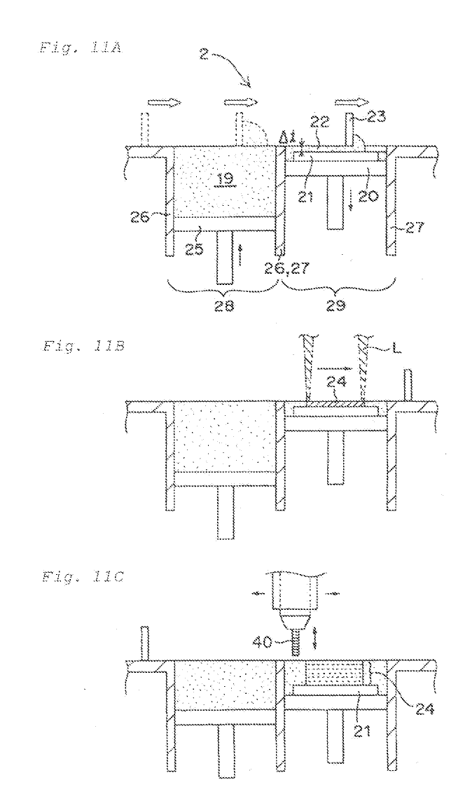

In the case of the use of the three-dimensional shaped object as the metal mold, it is preferable that the three-dimensional shaped object 100 includes a flow path 80 for cooling media therein as shown in FIG. 10. An existence of the flow path 80 for the cooling media allows the metal mold to be cooled. Accordingly, a proper temperature control of the metal mold is possible due to the use of both of the flow path 80 for the coolig media and the heat source element 12.

The flow path 80 for the cooling media has a hollow portion in the three-dimensional shaped object 100. The flow path 80 has a substantial same configuration as that of “the flow path for the heat media”. The flow path 80 having the hollow portion results from the substantial same process as that for the hollow portion of the flow path for the heat media. Specifically, in the middle of the stack of the solidified layers to be provided by the alternate repetition of the powder-layer forming and the solidified-layer forming, the flow path 80 for the cooling media results from a non-irradiated portion to be obtained by not solidifying a local region.

The number of the flow path 80 for the cooling media is not limited to one. A plurality of the flow path 80 for the cooling media may be provided. An extension direction of the flow path 80 for the cooling media is not limited to a specific direction, and the extension direction thereof may adopt a variety of directions. For example, it may be possible to provide the flow path 80 composed of one flow path 80a for the cooling media and another flow path 80b for the cooling media which are perpendicular to each other (see FIG. 10)

In the case of the use of the three-dimensional shaped object as the metal mold, the heat source element provided therein may be ON/OFF controllable. Specifically, it may be possible to use the heat source element which can change between a heat state and a non-heat state.

A process of obtaining the molded article from the raw material for the molding by using the metal mold are composed of the following five steps: (1) a step for clamping the metal mold; (2) a step for filling the raw material for the molding in the mold cavity and for subsequently pressurizing the filled raw material for the molding; (3) a step for cooling the raw material for the molding in the mold cavity; (4) a step for opening the mold; and (5) a step for removing the molded article. It is preferable that the heat source element in a state of “ON” is used in the steps (1) and (2). When the heat source element in the state of “ON” is used in the step (1), the metal mold is subjected to a heating process. This makes it possible to prevent a disadvantageous earlier cooling of the raw material for the molding when the raw material is filled in the mold cavity after the clamp of the metal mold. Similarly, when the heat source element in the state of “ON” is used in the step (2), it is possible to prevent a disadvantageous earlier cooling of the raw material for the molding which has been filled in the mold cavity. Please note that the needless earlier cooling of the raw material for the molding may cause an insufficient pressurization thereof in the mold cavity, and thus a molding defect may occur.

In light of the above matters, it is preferable to perform a control for being capable of using the heat source element in the state of “ON” in only the steps (1) and (2) (i.e., in only the case that the heating is necessary). Furthermore, a continuous “ON” state of the heat source element is not necessary in the step (1) (i.e., a step for clamping the metal mold). For example, the heat source element in the state of “ON” may be used at a stage just before performing the step (2). Similarly, a continuous “ON” state of the heat source element is not necessary in the step (2) (i.e., the step for filling the raw material for the molding and for subsequently pressurizing the filled raw materialfor the molding). For example, the heat source element in a state of “OFF” may be changed when the raw material reachs to a temperature at which the raw material has a fluidity. A proper use of the heat source element which is ON/OFF controllable makes it possible to more effectively perform the heating process of the metal mold.

In the case of the three-dimensional shaped object as the metal mold, the number of the heat source element is not limited to one, and a plurality of the heat source elements may be used.

For example, the plurality of the heat source elements may be provided at an internal region of the metal mold, the internal region being a region adjacent to a local portion of the cavity where the raw material for the molding supplied in the mold cavity finally reachs, the local portion of the cavity corresponding to a portion where the “weldline” is easy to occur. The plurality of the heat source elements allow a more effective heating of the portion where the weldline is easy to occur. As a result of the more effective heating, it is possible to more effectively prevent an occurrence of the molding defect to be caused by the weldline.

It is preferable that the plurality of the heat source elements are provided at an internal region of the metal mold, the internal region being adjacent to a cavity portion having a much smaller dimension of the mold cavity. For example, the cavity portion may have its thickness dimension of 0.1-1 mm. The cavity portion having the much smaller dimension may be a portion in which the raw material for the molding is difficult to flow. In light of the above matters, the plurality of the heat source elements allow a more effective heating of the raw material which is positioned in the cavity portion having the much smaller dimension.

Furthermore, a gas pressurization of the raw material for the molding filled in the mold cavity may be performed, the gas being supplied from an outside to the mold cavity. The gas pressurization may be performed from the outside through “a porous region having a lower solidified density” to the mold cavity, the porous region being provided in the metal mold such that it interconnects between the mold cavity and the outside for example. The gas pressurization allows “a mold transcription” to be further increased, which makes it possible to more effectively prevent an occurrence of sink marks in a molded article to be finally obtained, the sink marks corresponding to non-desired local depressions formed in a surface of the molded article. Furthermore, the porous region may be used for discharging the gas in the mold cavity. Specifically, a gas existing in the mold cavity before the filling of the raw material for the molding or upon the filling thereof may be discharged through the porous region to the outside.

Although the manufacturing method and the three-dimensional shaped object which is obtained thereby according to an embodiment of the present invention have been hereinbefore described, the present invention is not limited to the above embodiments. It will be readily appreciated by the skilled person that various modifications are possible without departing from the scope of the present invention.

It should be noted that the present invention as described above includes the following aspects:
The first aspect: A method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by forming a new powder layer on the formed solidified layer, followed by irradiation of a predetermined portion of the newly formed powder layer with the light beam,

wherein the three-dimensional shaped object is manufactured such that it has a heat source element in the three-dimensional shaped object, and also has a surface in a form of a concavity-convexity, and

wherein a main surface of the heat source element and the surface of the concavity-convexity have the same shape as each other.
The second aspect: The method according to the first aspect, wherein a spaced distance is rendered constant, the spaced distance being defined between the main surface of the heat source element and the surface in the form of the concavity-convexity.
The third aspect: The method according to the first or second aspect, wherein a heat-insulating porous region is formed in the three-dimensional shaped object, the heat-insulating porous region being located around the heat source element.
The fourth aspect: The method according to anyone of the first to third aspects, wherein a heater is used as the heat source element, and

wherein a heat generation surface of the heater has the same shape as that of the surface in the form of the concavity-convexity, the heat generation surface corresponding to the main surface of the heat source element.
The fifth aspect: The method according to any one of the first to fourth aspects, wherein a protection part for the heat source element is provided in the three-dimensional shaped object, the protection part being positioned on the main surface of the heat source element.
The sixth aspect: The method according to the fifth aspect, wherein the protection part for the heat source element and the heat source element have a close contact with each other.
The seventh aspect: The method according to any one of the first to third aspects, wherein a flow path for heating media is used as the heat source element, the flow path being formed in the three-dimensional shaped object, and

wherein a part of a wall surface of the flow path for the heating media has the same shape as that of the surface in the form of the concavity-convexity of the three-dimensional shaped object.
The eighth aspect: The method according to any one of the first to seventh aspects, wherein a heat transfer part is provided in the three-dimensional shaped object such that the heat transfer part is positioned at a region between the main surface of the heat source element and the surface of the three-dimensional shaped object.
The ninth aspect: A three-dimensional shaped object comprising a heat source element therein,

wherein the three-dimensional shaped object has a surface in a form of a concavity-convexity, and

wherein amain surface of the heat source element and the surface of the concavity-convexity have the same shape as each other.

### INDUSTRIAL APPLICABILITY

The manufacturing method according to an embodiment of the present invention can provide various kinds of articles. For example, in a case where the powder layer is a metal powder layer (i.e., inorganic powder layer) and thus the solidified layer corresponds to a sintered layer, the three-dimensional shaped object obtained by an embodiment of the present invention can be used as a metal mold for a plastic injection molding, a press molding, a die casting, a casting or a forging. While on the other hand in a case where the powder layer is a resin powder layer (i.e., organic powder layer) and thus the solidified layer corresponds to a cured layer, the three-dimensional shaped object obtained by an embodiment of the present invention can be used as a resin molded article.

### CROSS REFERENCE TO RELATED PATENT APPLICATION

The present application claims the right of priority of Japanese Patent Application No. 2015-152056 (filed on Jul. 31, 2015, the title of the invention: “METHOD FOR MANUFACTURING THREE-DIMENSIONAL SHAPED OBJECT AND THREE-DIMENSIONAL SHAPED OBJECT”), the disclosure of which is incorporated herein by reference.

### EXPLANATION OF REFERENCE NUMERALS

12 Heat source element
12A Main surface of heat source element
14 Heat-insulating porous region
16 Protection part for heat source element
18 Heat transfer part
22 Powder layer
24 Solidified layer
100 Three-dimensional shaped object
100A Surface in form of concavity-convexity of three-dimensional shaped object
L Light beam

1. A method for manufacturing a three-dimensional shaped object by alternate repetition of a powder-layer forming and a solidified-layer forming, the repetition comprising:
(i) forming a solidified layer by irradiating a predetermined portion of a powder layer with a light beam, thereby allowing a sintering of the powder in the predetermined portion or a melting and subsequent solidification of the powder; and
(ii) forming another solidified layer by forming a new powder layer on the formed solidified layer, followed by irradiation of a predetermined portion of the newly formed powder layer with the light beam,
wherein the three-dimensional shaped object is manufactured such that it has a heat source element in the three-dimensional shaped object, and also has a surface in a form of a concavity-convexity, and
wherein a main surface of the heat source element and the surface of the concavity-convexity have the same shape as each other.

2. The method according to claim 1, wherein a spaced distance is rendered constant, the spaced distance being defined between the main surface of the heat source element and the surface in the form of the concavity-convexity.

3. The method according to claim 1, wherein a heat-insulating porous region is formed in the three-dimensional shaped object, the heat-insulating porous region being located around the heat source element.

4. The method according to claim 1, wherein a heater is used as the heat source element, and
wherein a heat generation surface of the heater has the same shape as that of the surface in the form of the concavity-convexity, the heat generation surface corresponding to the main surface of the heat source element.

5. The method according to claim 1, wherein a protection part for the heat source element is provided in the three-dimensional shaped object, the protection part being positioned on the main surface of the heat source element.

6. The method according to claim 5, wherein the protection part for the heat source element and the heat source element have a close contact with each other.

7. The method according to claim 1, wherein a flow path for heating media is used as the heat source element, the flow path being formed in the three-dimensional shaped object, and
wherein a part of a wall surface of the flow path for the heating media has the same shape as that of the surface in the form of the concavity-convexity of the three-dimensional shaped object.

8. The method according to claim 1, wherein a heat transfer part is provided in the three-dimensional shaped object such that the heat transfer part is positioned at a region between the main surface of the heat source element and the surface of the three-dimensional shaped object.

9. A three-dimensional shaped object comprising a heat source element therein,
wherein the three-dimensional shaped object has a surface in a form of a concavity-convexity, and
wherein a main surface of the heat source element and the surface of the concavity-convexity have the same shape as each other.
